(19) United States
(12) Patent Application Publication
(10) Pub. No.: US 2013/0329293 A1
(43) Pub. Date: Dec. 12, 2013

(54) Optical Assembly Positioning Structure, LCD Device, and Manufacturing Method

(71) Applicants: Yicheng Kuo, Shenzhen (CN); Shihhsiang Chen, Shenzhen (CN); Gang Yu, Shenzhen (CN); Gege Zhou, Shenzhen (CN); Jiaqiang Wang, Shenzhen (CN)

(72) Inventors: Yicheng Kuo, Shenzhen (CN); Shihhsiang Chen, Shenzhen (CN); Gang Yu, Shenzhen (CN); Gege Zhou, Shenzhen (CN); Jiaqiang Wang, Shenzhen (CN)

(21) Appl. No.: 13/574,364

(22) PCT Filed: Jun. 12, 2012
(86) PCT No.: PCT/CN12/76754

§ 371 Date: Jul. 20, 2012

(30) Foreign Application Priority Data
Jun. 6, 2012 (CN) 201210183197.8

(51) Int. Cl. G02B 1/00; H01J 9/20

(52) U.S. Cl. CPC G02B 1/00; H01J 9/20
USPC 359/580; 445/24

(57) ABSTRACT

The invention provides an optical assembly positioning structure, an LCD device, and a manufacturing method thereof. The optical assembly positioning structure includes a positioning part and a clamping part used for clamping different optical layers of the optical assembly; a connecting part is arranged between the positioning part and the clamping part, and the positioning part is connected and fixed to one end of the clamping part by the connecting part. The optical layers of the optical assembly of the invention are fixed by separate positioning structures. The positioning part and clamping part of the positioning structure are respectively in contact with the upper and lower surfaces of the optical assembly. The positioning part is fixed and connected to the clamping part by the connecting part. Thus, all optical layers of the optical assembly are clamped and fixed. The optical assembly is assembled firstly, and then the assembled optical assembly is totally fixed in the backlight module, thereby reducing human power; in addition, all the optical layers are integratedly assembled, thereby effectively reducing the relative displacement between the optical layers, and ensuring that large scratch will not be generated between the optical layers.

### TECHNICAL FIELD

The invention relates to the field of liquid crystal displays (LCDs), and more particularly to an optical assembly positioning structure, an LCD device, and a manufacturing method thereof.

### BACKGROUND

An LCD device includes an LCD panel, and a backlight module. The backlight module is divided into a direct-light backlight module and a side-light backlight module according to the different position of light sources. For the side-light backlight module, an optical assembly is used to uniformly transmit light from the light emitting surface of the backlight module. The optical assembly includes a plurality of optical layers such as a light guide panel (LGP) and optical film(s). The optical film is generally formed by stacking a plurality of sub-films. With the development trend of light and thin LCD devices, optical assembly positioning structures are gradually simplified. In a conventional corner type fixing structure of a backlight module, the optical films of the optical assembly are only fixed on the corners of the backlight module. Although the structure can save space, the fixation strength of the optical films is reduced. Therefore, relative displacement is easily generated between optical layers of the optical assembly in the processes of assembly, transportation and the like, thereby easily scratching the surface of each optical layer.

### SUMMARY

In view of the above-described technical problems, the aim of the invention is to provide an optical assembly positioning structure capable of reducing the scratch of the optical assembly, an LCD device, and a manufacturing method thereof.

The aim of the invention is achieved by the following technical scheme.

An optical assembly positioning structure, the positioning structure comprises a positioning part and a clamping part used for clamping different optical layers of the optical assembly; a connecting part is arranged between the positioning part and the clamping part, and one end of the positioning part is connected and fixed to one end of the clamping part by the connecting part.

Preferably, one end of the positioning part is provided with a positioning lug boss contacting with the optical assembly, and the other end of the positioning part is fixed and connected to the clamping part by the connecting part. By the contact between the positioning lug boss and the optical assembly, the contact area between the positioning part and the optical assembly can be reduced. The intensity of pressure can be increased by reducing the contact area on the premise of the same certain pressure, so that all the optical layers of the optical assembly are tightly positioned.

Preferably, one end of the clamping part is provided with a clamping lug boss contacting with the optical assembly, and the other end of the clamping part is fixed and connected to the positioning part by the connecting part. By the contact between the positioning lug boss and the optical assembly, the contact area between the clamping part and the optical assembly can be reduced. The intensity of pressure can be increased by reducing the contact area on the premise of the same certain pressure, so that all the optical layers of the optical assembly are tightly positioned. By combining with the technical scheme of the positioning structure comprising lug bosses, a symmetrical structure can be formed. Either structure can be in contact with the optical film or the LGP, and has high generality.

Preferably, both the contact surface between the positioning part and the optical assembly, and the contact surface between the clamping part and the optical assembly are provided with flexible spacers. By adding the flexible spacers on the contact surfaces, the positioning structure can be prevented from scratching the optical assembly and then affecting the display quality.

Preferably, the distance between the positioning part and the clamping part is consistent with the total thickness of the optical film layers of the optical assembly. For the optical assembly with multiple optical films, the positioning structure is only used for clamping the optical films. The optical films can be assembled firstly, and then fixed in the backlight module, thereby improving the assembling efficiency.

An LCD device comprises an optical assembly. The optical assembly comprises at least two optical layers. Different optical layers of the optical assembly are clamped and fixed by the aforementioned optical assembly positioning structure.

Preferably, the optical assembly comprises an LGP, and optical film(s) arranged on the light emitting surface of the LGP. The LGP and the optical film are clamped and fixed by the positioning structure, and the LGP and the optical film constitute at least two optical layers. This is one positioning structure between the optical film and the LGP. The LGP and the optical film can be fixed firstly, and then arranged in the backlight module, thereby improving the assembling efficiency.

Preferably, the positioning structures are clamped on both sides of the light incident surface of the optical assembly. This is a technical scheme of symmetrical clamping. Two opposite sides are clamped, thereby obtaining uniform stress, and good fixing effect; meanwhile, the cost is saved when guaranteeing the fixing effect without using the positioning structure on each side.

Preferably, the optical assembly comprises an LGP, and optical film(s) arranged on the light emitting surface of the LGP. The number of the optical film(s) is at least two. A film group is formed after stacking the different optical films. Both the upper and lower surfaces of the film group are clamped and fixed by the positioning structure. This is a positioning structure between the optical films. The optical films can be assembled, and then fixed in the backlight module, thereby improving the assembling efficiency.

Preferably, each side of the optical assembly is provided with at least one positioning structure. This is a positioning structure of multiple side clamping. Because the side surface of each optical film does not require incident light/emitting light, each side can be clamped. Thus, the optical films are more reliably fixed.

A manufacturing method of an LCD device comprises the following steps:

A: Clamping and fixing each optical layer of the optical assembly by the aforementioned optical assembly positioning structure; and

B: Fixing the assembled optical assembly in the backlight module of the LCD device.

The optical layers of the optical assembly of the invention are fixed by separate positioning structures. The positioning part and clamping part of the positioning structure are respectively in contact with the upper and lower surfaces of the optical assembly. The positioning part is connected and fixed to the clamping part by the connecting part. Thus, all the optical layers of the optical assembly are clamped and fixed. By the structure, the optical assembly is assembled firstly during assembly, and then the assembled optical assembly is totally fixed in the backlight module, thereby reducing human power; in addition, all the optical layers are integratedly assembled, thereby effectively reducing the relative displacement between the optical layers, and ensuring that large scratch will not be generated between the optical layers.

### BRIEF DESCRIPTION OF FIGURES

FIG. 1 is a schematic diagram of a conventional optical assembly positioning structure;

FIG. 2 is a schematic diagram of a positioning structure simultaneously clamping an LGP and an optical film of an example of the invention;

FIG. 3 is a schematic diagram of a positioning structure separately clamping an optical film of an example of the invention;

FIG. 4 is a schematic diagram of positioning structures clamping multiple sides of an optical assembly of the invention;

FIG. 5 is a schematic diagram of an optical assembly positioning structure of an example of the invention; and

FIG. 6 is a schematic diagram of an optical assembly positioning structure with flexible spacers of an example of the invention.

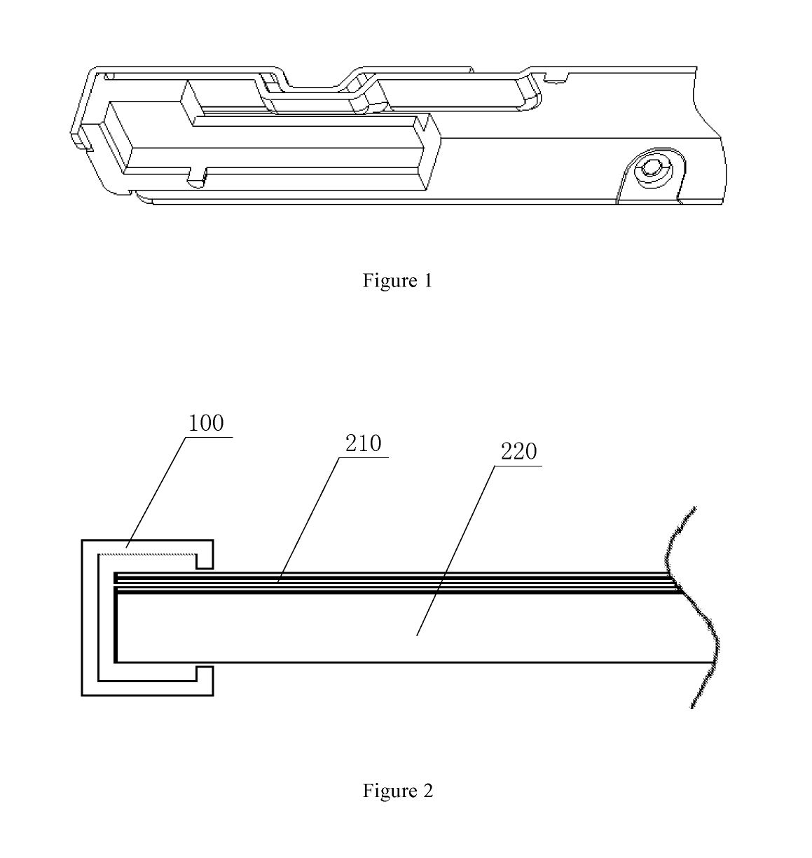

Legends: 100 positioning structure; 110. positioning part; 111. positioning lug boss; 120. clamping part; 121. clamping lug boss; 130. connecting part; 140. flexible spacer; 200. optical assembly; 210. optical film; 220. LGP.

### DETAILED DESCRIPTION

The invention will be further described in accordance with the Figures and preferred examples.

An LCD device comprises an optical assembly. The optical assembly comprises a plurality of optical layers. One of the optical layers is an LGP, and the rest optical layers are optical film(s) arranged on the light emitting surface of the LGP. The number of the optical film(s) can be one, and can be multiple as well. The different optical layers of the optical assembly are clamped and fixed by an optical assembly positioning structure.

The optical layers of the optical assembly of the invention are fixed by separate positioning structures. The positioning part and clamping part of the positioning structure are respectively in contact with the upper and lower surfaces of the optical assembly. The positioning part is connected and fixed to the clamping part by the connecting part. Thus, all optical layers of the optical assembly are clamped and fixed. The optical assembly is assembled firstly, and then the assembled optical assembly is totally fixed in the backlight module, thereby reducing human power; in addition, all the optical layers are integratedly assembled, thereby effectively reducing the relative displacement between the optical layers, and ensuring that large scratch will not be generated between the optical layers.

Specifically speaking, as shown in FIG. 2, the positioning structure 100 can simultaneously clamp the LGP 220 and the optical film 210. Thus, the LGP 220 and the optical film 210 are fixed firstly, and then are arranged in the backlight module, thereby improving the assembling efficiency.

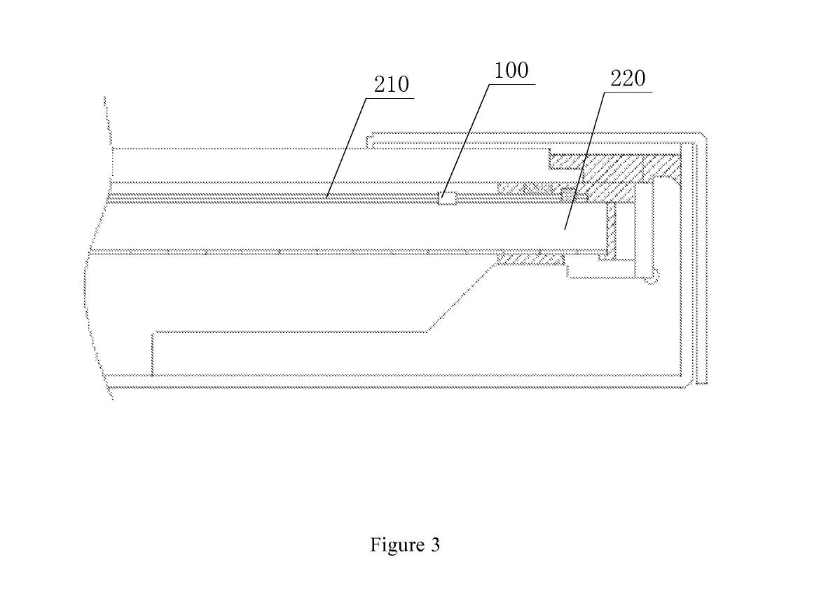

Optionally, for the LCD device with a plurality of optical films 210, as shown in FIG. 3, the positioning structure 100 is used for clamping a plurality of optical films 210 simultaneously. This is a positioning structure 100 between the optical films 210. The optical films 210 can be assembled firstly, and then the assembled optical films 210 are fixed in the backlight module, thereby improving the assembling efficiency. Moreover, because the LGP is thick and heavy, the fixing structure is required to have high clamping force and high strength when simultaneously clamping the LGP and the optical films, and more material or better material is required to be used. If only the optical films are clamped, the material requirement can be reduced, favoring the reduction of the material cost.

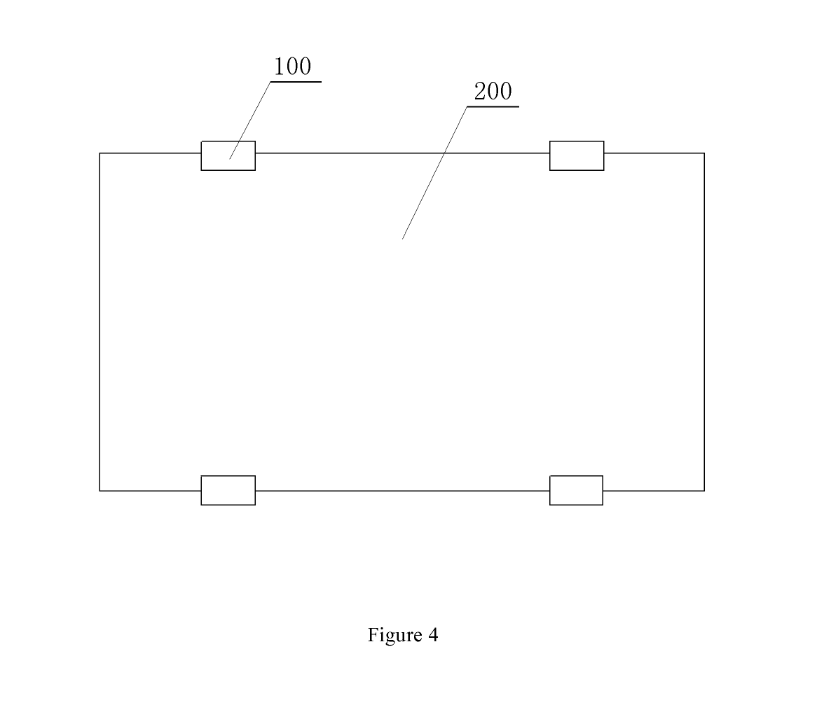

For the technical scheme that the positioning structure simultaneously clamps the LGP and the optical film, to improve the positioning effect, the positioning structures 100 are clamped on both sides of the light incident surface of the optical assembly 200 (as shown in FIG. 4). Thus, the two opposite sides are clamped, thereby obtaining uniform stress, and good fixing effect; meanwhile, the cost is saved when guaranteeing the fixing effect without using the positioning structure on each side.

For the technical scheme that the positioning structure only clamps the optical films, because the side surface of each optical film does not require incident light/emitting light, each side can be clamped. Thus, the optical films are more reliably fixed.

The invention further provides a specific structure of the positioning structure 100.

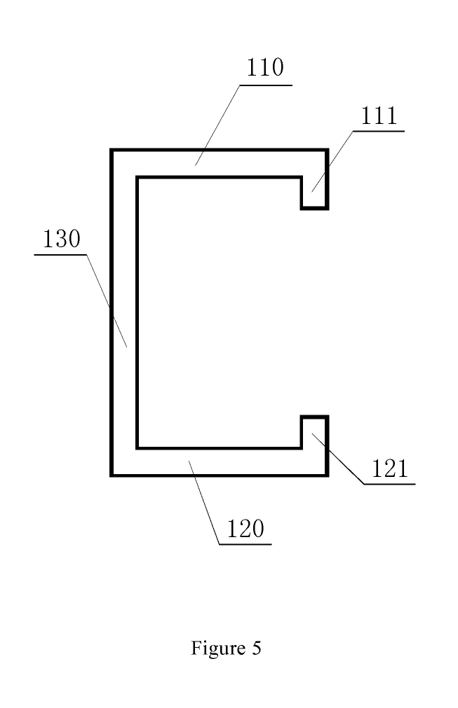

As shown in FIG. 5, the positioning structure 100 comprises a positioning part 110 used for clamping different optical layers of the optical assembly, and a clamping part 120; a connecting part 130 is arranged between the positioning part 110 and the clamping part 120. One end of the positioning part 110 is provided with a positioning lug boss 111 contacting with the optical assembly; one end of the clamping part 120 is provided with a clamping lug boss 121 contacting with the optical assembly, and the other end of the positioning part 110 is fixedly connected with that of the clamping part 120 by the connecting part 130. By the contact of the optical assembly with the positioning lug boss 111 and the clamping lug boss 121, the contact area between the positioning part 110 or the clamping part 120 and the optical assembly can be reduced. The intensity of pressure can be increased by reducing the contact area on the premise of the same certain pressure, so that all the optical layers of the optical assembly are tightly positioned. Optionally, the positioning part 110 and the clamping part 120 may be not provided with lug boss as long as the positioning part 110 and the clamping part 120 can be in contact with the surface of the optical assembly.

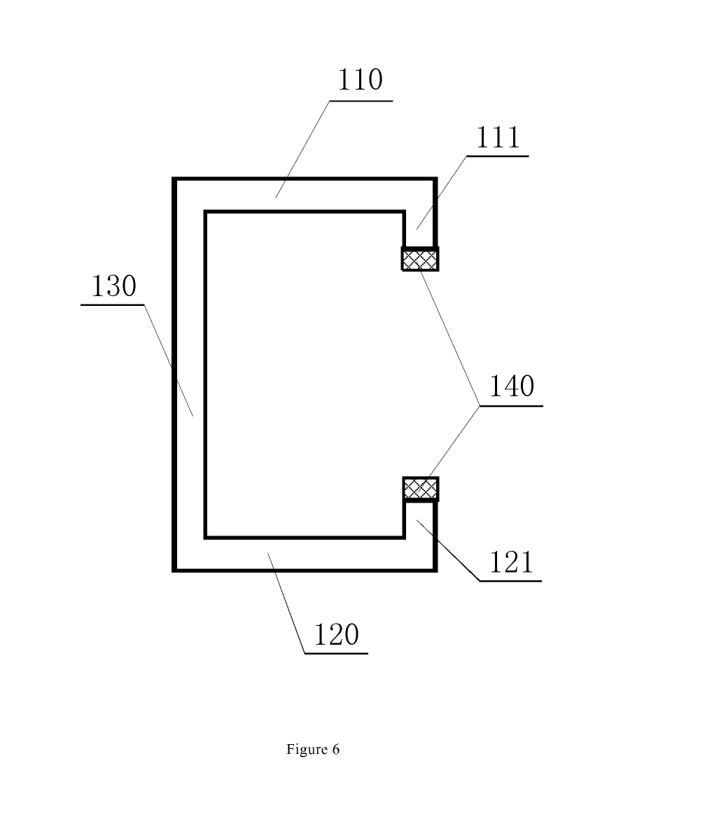

As shown in FIG. 6, the contact surfaces between the positioning part 110 and the optical assembly, and the clamping part 120 and the optical assembly are respectively provided with flexible spacers 140 to prevent the optical assembly from being scratched by the positioning structure.

When the positioning structure 100 clamps, the positioning part 110, the clamping part 120, etc. are required to be pulled open; when the optical layers to be clamped are pushed between the positioning part 110 and the clamping part 120, sufficient elastic stress is required to tightly press all the optical layers. Therefore, at least one of the positioning part 110, the clamping part 120, and the connecting part 130 is required to be made of rigid material.

First combination of materials: the positioning part and the clamping part are made of hard material, and the connecting part is made of rigid material. Rigid material has high deformation resistance. When using the positioning structure, the opening between the positioning part and the clamping part should be widened. Thus, elastic deformation is generated on the connecting part. When the optical films and the edge of the LGP are pushed between the positioning part and the clamping part and then released, the elastic stress generated by the connecting part acts on the positioning part and the clamping part, so that the optical films and the LGP are tightly pressed.

Second combination of materials: the positioning part and the clamping part are made of rigid material, and the connecting part is made of hard material. Rigid material has high deformation resistance. When using the positioning structure, the opening between the positioning part and the clamping part should be widened. Because of being made of hard material, the connecting part has small deformation. Thus, the deformation generated at the opening is concentrated on the positioning part and the clamping part; when the optical films and the edge of the LGP are pushed between the positioning part and the clamping part and then released, the optical films and the LGP are tightly pressed by the positioning part and the clamping part under the action of different elastic stress.

Third combination of materials: all the positioning part, the clamping part and the connecting part are made of rigid material. Because all the three are made of rigid material, the overall elastic stress becomes uniform, thereby favoring the integration by using the same material, and the reduction of production cost.

The invention further provides a manufacturing method of the LCD device, comprising the following steps:

A: Clamping and fixing each optical layer of the optical assembly by the aforementioned optical assembly positioning structure; and

B: Fixing the assembled optical assembly in the backlight module of the LCD device.

The invention is described in detail in accordance with the above contents with the specific preferred examples. However, this invention is not limited to the specific examples. For the ordinary technical personnel of the technical field of the invention, on the premise of keeping the conception of the invention, the technical personnel can also make simple deductions or replacements, and all of which should be considered to belong to the protection scope of the invention.

We claim:

1. An optical assembly positioning structure, wherein said positioning structure comprises a positioning part and a clamping part used for clamping different optical layers of said optical assembly; a connecting part is arranged between said positioning part and said clamping part, and said positioning part is connected and fixed to one end of said clamping part by said connecting part.

2. The optical assembly positioning structure of claim 1, wherein one end of said positioning part is provided with a positioning lug boss contacting with said optical assembly, and the other end of said positioning part is fixed and connected to said clamping part by said connecting part.

3. The optical assembly positioning structure of claim 1, wherein one end of said clamping part is provided with a clamping lug boss contacting with said optical assembly, and the other end of said clamping part is fixed and connected to said positioning part by said connecting part.

4. The optical assembly positioning structure of claim 1, wherein both the contact surfaces between said positioning part and said optical assembly, and the contact surface between said clamping part and said optical assembly are respectively provided with flexible spacers.

5. The optical assembly positioning structure of claim 1, wherein the distance between said positioning part and said clamping part is consistent with the total thickness of the optical film layers of said optical assembly.

6. An LCD device, comprising: an optical assembly; wherein said optical assembly comprises an optical assembly positioning structure, and at least two optical layers; the different optical layers of said optical assembly are clamped and fixed by said optical assembly positioning structure; said optical assembly positioning structure comprises a positioning part and a clamping part used for clamping different optical layers of said optical assembly; a connecting part is arranged between said positioning part and said clamping part, and one end of said positioning part is connected and fixed to one end of said clamping part by said connecting part.

7. The LCD device of claim 6, wherein one end of said positioning part is provided with a positioning lug boss contacting with said optical assembly, and the other end of said positioning part is fixed and connected to said clamping part by said connecting part.

8. The LCD device of claim 6, wherein one end of said clamping part is provided with a clamping lug boss contacting with said optical assembly, and the other end of said clamping part is fixed and connected to said positioning part by said connecting part.

9. The LCD device of claim 6, wherein both the contact surface between said positioning part and said optical assembly, and the contact surface between said clamping part and said optical assembly are respectively provided with flexible spacers.

10. The LCD device of claim 6, wherein the distance between said positioning part and said clamping part is consistent with the total thickness of the optical film layers of said optical assembly.

11. The LCD device of claim 6, wherein said optical assembly comprises an LGP, and optical film(s) arranged on the light emitting surface of said LGP; said LGP and said optical film are clamped and fixed by said positioning structure, and said LGP and said optical film constitute at least two optical layers.

12. The LCD device of claim 11, wherein said positioning structures are clamped on both sides of the light incident surface of said optical assembly.

13. The LCD device of claim 6, wherein said optical assembly comprises an LGP, and optical film(s) arranged on the light emitting surface of said LGP; the number of said optical film(s) is at least two; a film group is formed after stacking said different optical films, and both the upper and lower surfaces of said film group are clamped and fixed by said positioning structure.

14. The LCD device of claim 13, wherein each side of said optical assembly is provided with at least one said positioning structure.

15. A manufacturing method of the LCD device, comprising: the following steps:
A: Clamping and fixing each optical layer of said optical assembly by said optical assembly positioning structure; the different optical layers of said optical assembly are clamped and fixed by said optical assembly positioning structure; said optical assembly positioning structure comprises a positioning part and a clamping part used for clamping different optical layers of said optical assembly; a connecting part is arranged between said positioning part and said clamping part, and said positioning part is connected and fixed to one end of said clamping part by said connecting part;
B: Fixing said assembled optical assembly in the backlight module of said LCD device.

16. The manufacturing method of the LCD device of claim 15, wherein in said step A, one end of said positioning part is provided with a positioning lug boss contacting with said optical assembly, and the other end of said positioning part is fixed and connected to said clamping part by said connecting part.

17. The manufacturing method of the LCD device of claim 15, wherein in said step A, one end of said clamping part is provided with a clamping lug boss contacting with said optical assembly, and the other end of said clamping part is fixed and connected to said positioning part by said connecting part.

18. The manufacturing method of the LCD device of claim 15, wherein in said step A, both the contact surface between said positioning part and said optical assembly, and the contact surface between said clamping part and said optical assembly are respectively provided with flexible spacers.

19. The manufacturing method of the LCD device of claim 15, wherein in said step A, the distance between said positioning part and said clamping part is consistent with the total thickness of the optical film layers of said optical assembly.
